(19) United States
(12) Patent Application Publication
(10) Pub. No.: US 2021/0206792 A1
(43) Pub. Date: Jul. 8, 2021

(54) COMPLEX TRANSITION METAL PHOSPHONATES

(71) Applicant: QATAR FOUNDATION FOR EDUCATION, SCIENCE AND COMMUNITY DEVELOPMENT, Doha (QA)

(72) Inventors: Rachid ESSEHLI, Doha (QA); Ilias BELHAROUAK, Doha (QA); Hamdi BEN YAHIA, Doha (QA); Ali ABOUIMRANE, Doha (QA)

(73) Assignee: Qatar Foundation for Education, Science and Community Development, Doha (QA)

(21) Appl. No.: 15/777,600

(22) PCT Filed: Nov. 20, 2016
(86) PCT No.: PCT/QA2016/050009

§ 371 Date: May 18, 2018

Related U.S. Application Data
(60) Provisional application No. 62/257,682, filed on Nov. 19, 2015.

(51) Int. Cl. C07F 15/06; H01M 10/0525; H01M 10/36; C07F 15/02; H01M 4/62; H01M 4/583; H01M 10/0568; H01M 10/0569; H01M 4/60

(52) U.S. Cl. CPC C07F 15/065; H01M 10/0525; H01M 10/36; C07F 15/025; H01M 4/623; H01M 2300/002; H01M 10/0568; H01M 10/0569; H01M 4/60; H01M 2300/004; H01M 4/583

(57) ABSTRACT

The complex transition metal phosphonates include one or more of compounds with the chemical formula: (1) AₓM_{y}(R(PO₃)₂)_{z}; (2) AₓM_{y}(RPO₃)_{z}; (3) AₓM_{y}(R(PO₃)₂; nHO; (4) AₓM_{y}(RPO₃); nH₂O; and (5) AₓM_{y}(R(PO₃)₂)_{z}(X)ₜ, where A is an alkali metal or an alkaline earth metal, M is a divalent or trivalent transition metal, R is an organic group, and X is OH, F or CI. For example, A is Li, Na, K, Cs, Rb, Mg, Ca and/or combinations thereof. M is Ni, Co, Mn, Fe, Cr, V, Ti, Cu and/or combinations thereof. R is a C1-C5 alkyl group; e.g., CH₂, C₂H₄, or C₃H₆, The complex transition metal phosphonates can be used as cathode or anode materials for rechargeable batteries.

### TECHNICAL FIELD

The present invention relates to phosphonates, and particularly to phosphonates as electroactive materials for rechargeable batteries.

### BACKGROUND ART

The use of rechargeable batteries has increased substantially in recent years as global demand for technological products such as laptop computers, cellular phones, and other consumer electronic products has rapidly increased. One popular type of rechargeable battery is the lithium ion battery. Compared to other types of rechargeable batteries, lithium to ion batteries provide high energy densities, lose a minimal amount of charge when not in use, and do not exhibit memory effects. Due to these beneficial properties, lithium ion batteries have found widespread use in various electronic fields such as cell phones and laptop computers. The high energy density characteristics of these batteries mean that they can also be used in aerospace, military and vehicle applications.

A lithium ion rechargeable battery cell typically comprises an anode, a cathode and an electrolyte. Traditional lithium ion rechargeable batteries have employed liquid electrolytes, such as a lithium-salt electrolyte (e.g., LiPF₆, LiBF₄, or LiClO₄) mixed with an organic solvent (e.g., alkyl carbonate). As the battery is discharged to produce electrons, the electrolyte provides a medium for ion flow between the electrodes, and the electrons flow between the electrodes through an external circuit. However, the existing rechargeable batteries (e.g., lithium ion batteries) are incapable of operating safely over a wide range of temperatures of interest. The energy density of existing rechargeable batteries is also inadequate for many applications. The mobility and diffusion of the electrolyte within the electrode is also not efficient. Thus, complex transition metal phosphonates solving the aforementioned problems are desired.

### DISCLOSURE OF INVENTION

The complex transition metal phosphonates include one or more of compounds with the chemical formula: (1) AₓM_{y}(R(PO₃)₂)_{z}; (2) AₓM_{y}(RPO₃)_{z}; (3) AₓM_{y}(R(PO₃)₂)_{z}.nH₂O; (4) AₓM_{y}(RPO₃)_{z}.nH₂O; and (5) AₓM_{y}(R(PO₃)₂)_{z}(X)ₜ, where A is an alkali metal or an alkaline earth metal, M is a divalent or trivalent transition metal, R is an organic group, and X is OH, F or Cl. For example, A is Li, Na, K, Cs, Rb, Mg, Ca and/or combinations thereof. M is Ni, Co, Mn, Fe, Cr, V, Ti, Cu and/or combinations thereof. R is a C₁-C₅ alkyl group; e.g., CH₂, C₂H₄, or C₃H₆. The complex transition metal phosphonates can be used as cathode or anode materials for rechargeable batteries.

These and other features of the present invention will become readily apparent upon further review of the following specification and drawings.

### BRIEF DESCRIPTION OF THE DRAWINGS

FIG. 1 is a graph showing the charge/discharge curves of Na₂Co(O₃P—CH₂—PO₃), recorded at room temperature, at the rate of 20 mA/g.

FIG. 2 is a graph showing a cyclic Voltammogram curve (CV) of Na₂Fe(O₃P—CH₂—PO₃) recorded at room temperature between 1.5-5 V vs. Na⁺/Na, with a scanning rate of 0.2 mVs⁻¹.

Similar reference characters denote corresponding features consistently throughout the attached drawings.

### BEST MODES FOR CARRYING OUT THE INVENTION

The complex transition metal phosphonates include one or more of compounds with the chemical formula: (1) AₓM_{y}(R(PO₃)₂)_{z}; (2) AₓM_{y}(RPO₃)_{z}; (3) AₓM_{y}(R(PO₃)₂)_{z}.nH₂O; (4) AₓM_{y}(RPO₃)_{z}.nH₂O; and (5) AₓM_{y}(R(PO₃)₂)_{z}(X)ₜ, where A is an alkali metal or an alkaline earth metal, M is a divalent or trivalent transition metal, R is an organic group, and X is OH, F or Cl. For example, A is Li, Na, K, Cs, Rb, Mg, Ca and/or combinations thereof. M is Ni, Co, Mn, Fe, Cr, V, Ti, Cu and/or combinations thereof. R is a C₁-C₅ alkyl group, e.g., CH₂, C₂H₄, or C₃H₆. X is OH, F, or Cl.

The complex transition metal phosphonates can be used as electroactive materials for rechargeable batteries, e.g., Na-ion, K-ion, Li-ion and Mg-ion batteries. In particular, the complex transition metal phosphonates can be used as anode and/or cathode materials for rechargeable batteries. The complex transition metal phosphonates can be used as insertion materials that enable the mobility and diffusion of Li, Na; K, Cs, Rb, Mg and Ca ions. The complex transition metal phosphonates can have a crystalline structure or amorphous state. The crystalline structure can depend upon the A:M ratio. The A:M ratio can be from about 0.5 to about 3. For example, the crystalline structure of the phosphonates can be tuned depending upon the ratio A/M (from 0.5 to 3) wherein the degree of condensation of the [MOₙ] coordination polyhedra is let to vary from isolated [MOₙ] groups to corner or edge sharing groups.

In some cases, the complex transition metal phosphonates can be dissolved in carbonate, ether or water for use as soluble active materials for flow battery applications. The complex transition metal phosphonates can be made by ionothermal methods and/or solvothermal methods using alkyl-phosphonate, as is known in the art. Ionothermal methods are described, for example, in Recham, N. et al., “A 3.6 V lithium-based fluorosulphate insertion positive electrode for lithium-ion batteries,” Nature Mater. 9: 68-74 (2010) (preparation of inorganic materials). Solvothermal methods are described, for example, in Journal of Power Sources, Volume 210: 47-53 (2012) (preparation of LiFePO₄ cathode materials).

In the ionothermal method, the complex transition metal phosphonates are prepared using an ionic liquid. Ionic liquids include room-temperature molten salts with negligible vapor pressure, exhibiting properties of non-flammability, high thermal stability and wide liquid range that can allow the use of high temperature preparation. For example, transition metal acetate, sodium acetate and alkyl phosphates are dissolved in the ionic liquid, such as ethyl methyl imidazolium compound, and heated at 120° C. for 12 hours. Then, the ionic liquid solvent is removed by vacuum evaporation method and the resultant mixture is heated on the oven at a temperature of 250° C. for 8 hours. In the solvothermal method, the same precursors (transition metal acetate, sodium acetate and alkyl phosphate) are mixed in a stainless steel autoclave using ethylene glycol as a solvent. The mixture is heated under pressure at 160° C. for about 6 hours. The autoclave allows the reaction to be conducted without the evaporation of the solvent. The mixture is recovered and heated in the oven at a temperature of 250° C. for 8 hours. The following examples will further illustrate the synthesis process for the complex transition metal phosphonates.

### Example 1

The disodium iron methylene bisphosphonate Na₂Fe(O₃P—CH₂—PO₃) was obtained by solvothermal method from a mixture of methylenebisphosphonic acid, FeSO₄.7H₂O, NaOH, and ethylene glycol. A certain amount of FeSO₄.7H₂O and methylenediphosphonic acid with a mole ratio of 1/1 were dissolved in 20 ml ethylene glycol (EG) solution, and the pH was adjusted to 10 by adding amounts of NaOH (1M). The mixture was kept stirring for additional half hour at 50° C. After that, the mixture products were transferred inside a 40 ml stainless steel autoclave and heated at 200° C. for 4 days. The final products were washed three times with distilled water and dried at 50° C. in a vacuum oven overnight.

### Example 2

The disodium cobalt methylene bisphosphonate Na₂Co(O₃P—CH₂—PO₃) was obtained by solvothermal method from a mixture of methylenediphosphonic acid, CoSO₄.6H₂O, NaOH, ethylene glycol and water. A certain amount of CoSO₄.6H₂O and methylenediphosphonic acid with a mole ratio of 1/1 were dissolved in 20 ml ethylene glycol (EG/H₂O) solution, and the pH was adjusted to 10 with NaOH. The mixture was kept stirring for additional half hour at 50° C. After that, the mixture products were transferred inside a 40 ml stainless steel autoclave and heated at 200° C. for 3 days. The final products were washed three times with distilled water and dried at 50° C. in a vacuum oven overnight.

### Example 3

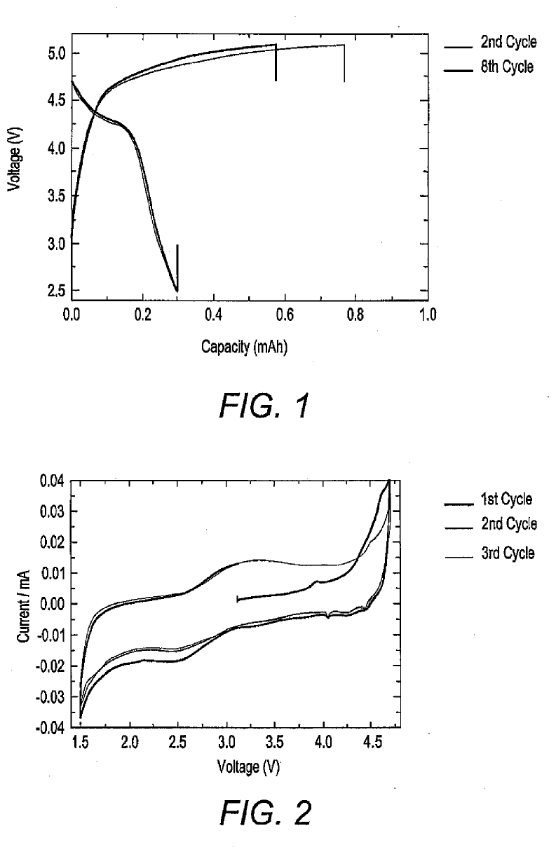

The sample of Example 2 was tested as cathode material for sodium batteries. The working electrodes composite was prepared by mechanical mixing of 60 wt. % active material with 30 wt. % Super P carbon and 10 wt. % polyvinylidene fluoride as polymer binder. The electrode was prepared by casting the slurry onto aluminum foil with a doctor blade and drying in a vacuum oven at 110° C. overnight. The CR2032 coin-type cells were assembled with pure sodium foil as the counter electrode, and glass fiber as the separator in an argon-filled glove box. The electrolyte was 0.2 mol/L NaPF₆ dissolved in a 1:1 mixture of ethylene carbonate (EC) and propylene carbonate (PC). Electrochemical experiments were carried out with a multichannel potentiostat galvanostat. FIG. 1 shows the galvanostic curve with a reversible electrochemical activity at 4.2V.

### Example 4

The sample of Example 1 was tested as cathode material for sodium batteries. The working electrodes composite was prepared by mechanical mixing of 60 wt. % active material with 30 wt. % Super P carbon and 10 wt. % polyvinylidene fluoride as polymer binder. The electrode was prepared by casting the slurry onto aluminum foil with a doctor blade and drying in a vacuum oven at 110° C. overnight. The CR2032 coin-type cells were assembled with pure sodium foil as the counter electrode, and glass fiber as the separator in an argon-filled glove box. The electrolyte was 0.2 mol/L NaPF6 dissolved in a 1:1 mixture of ethylene carbonate (EC) and propylene carbonate (PC). Electrochemical experiments were carried out with a multichannel potentiostat galvanostat, FIG. 2 shows the cyclic voltammetry curves having an oxidation peak at 3.2V and a reduction peak at 2.5V.

It should be understood that a rechargeable battery having an electrode made from the present complex transition metal phosphonate may take the form of a lithium-ion battery, a lithium air battery, a lithium sulphur battery, a lithium battery, a sodium-ion battery, a sodium battery, a magnesium-ion battery, a magnesium battery, a potassium-ion battery, a potassium battery, a flow battery or the like.

It is to be understood that the present invention is not limited to the embodiments described above, but encompasses any and all embodiments within the scope of the following claims.

We claim:

1. A complex transition metal phosphonate having a formula selected from the group consisting of AₓM_{y}(R(PO₃)₂)_{z}, AₓM_{y}(RPO₃)_{z}, AₓM_{y}(R(PO₃)₂)_{z}.nH₂O, AₓM_{y}(RPO₃)_{z}.nH₂O and AₓM_{y}(R(PO₃)₂)_{z}(X)ₜ, where A is an alkali metal or an alkaline earth metal; M is a divalent or trivalent transition metal; R is an organic group; X is OH, F, or Cl; and n is the number of water molecules in hydrated phosphonates.

2. The complex transition metal phosphonates of claim 1, wherein A is selected from the group consisting of of Li, Na; K, Cs, Rb, Mg and Ca.

3. The complex transition metal phosphonates of claim 1, wherein M is selected from the group consisting of Ni, Co, Mn, Fe, Cr, V, Ti, and Cu.

4. The complex transition metal phosphonates of claim 1, wherein R is a C₁-C₅ alkyl group.

5. An electrode for a rechargeable battery, comprising an electrode made from a complex transition metal phosphonate according to claim 1.

6. The electrode for a rechargeable battery according to claim 5, wherein the electrode comprises a cathode.

7. The electrode for a rechargeable battery according to claim 5, wherein the electrode comprises an anode.

8. A rechargeable battery having an electrode made from a complex transition metal phosphonate according to claim 1, the battery being selected from the group consisting of a lithium-ion battery, a lithium air battery, a lithium sulphur battery, and a lithium battery.

9. A rechargeable battery having an electrode made from a complex transition metal phosphonate according to claim 1, the battery being selected from the group consisting of a sodium-ion battery and a sodium battery.

10. A rechargeable battery having an electrode made from a complex transition metal phosphonate according to claim 1, the battery being selected from the group consisting of a magnesium-ion battery and a magnesium battery.

11. A rechargeable battery having an electrode made from a complex transition metal phosphonate according to claim 1, the battery being selected from the group consisting of a potassium-ion battery and a potassium battery.

12. A rechargeable battery having an electrode made from a complex transition metal phosphonate according to claim 1, the battery being a flow battery.

13. The complex transition metal phosphonates of claim 1, wherein the complex transition metal phosphonate is soluble in a solvent selected from the group consisting of carbonate solvents, ether solvents, water, and combinations thereof.

14. A complex transition metal methylene bisphosphonate having a formula selected from the group consisting of AₓM_{y}(R(PO₃)₂)_{z}, AₓM_{y}(RPO₃)_{z}, AₓM_{y}(R(PO₃)₂)_{z}.nH₂O, AₓM_{y}(RPO₃)_{z}.nH₂O and AₓM_{y}(R(PO₃)₂)_{z}(X)ₜ, where A is an alkali metal or an alkaline earth metal; M is a divalent or trivalent transition metal; R is an organic group; X is OH, F, or Cl; and n is the number of water molecules in hydrated phosphonates.

15. The complex transition metal methylene bisphosphonate of claim 14, wherein the formula comprises Li₂Fe(CH₂(PO₃)₂)₁.

16. The complex transition metal methylene bisphosphonate of claim 14, wherein the formula comprises Na₂Fe(CH₂(PO₃)₂)₁.

17. The complex transition metal methylene bisphosphonate of claim 14, wherein the formula comprises Na₂Co(CH₂(PO₃)₂)₁.
